(19) United States
(12) Patent Application Publication
(10) Pub. No.: US 2025/0197235 A1
(43) Pub. Date: Jun. 19, 2025

(54) METHOD FOR THE REDUCTION OF THE ORP, AS WELL AS INCREASING PH LEVELS TO NEUTRAL FOR THE USE IN A DLE PROCESS DEVICE

(71) Applicant: TETRA Technologies Inc., The Woodlands, TX (US)

(72) Inventors: Arthur Mack, The Woodlands, TX (US); Zheng Chai, The Woodlands, TX (US); Stanley Gunawan, The Woodlands, TX (US)

(73) Assignee: TETRA Technologies Inc, The Woodlands, TX (US)

(21) Appl. No.: 18/540,199

(22) Filed: Dec. 14, 2023

(51) Int. Cl. C01D 15/08; B01D 15/36

(52) U.S. Cl. CPC C01D 15/08; B01D 15/361

(57) ABSTRACT

The present disclosure provides various characteristics for treating tail brine extracted from a bromine plant, when said brine contains residual bromine and chlorine with low pH and high ORP values that will be used in a lithium extraction production facility. The method conditions the extracted tail brine by adding either sodium hydroxide or ammonium hydroxide to bring its pH levels to between 5.5 and 6.5. The conditioned tail brine then gets pre-treated with hydrazine in either less than 70 ppm if used in combination with sodium hydroxide; or 195 ppm if used with ammonium hydroxide until the ORP levels have reached to below 100 mV. The extracted tail brine is then processed through DLE processing device having four groups of adsorption columns filled with lithium adsorption resins that, after treating the extracted tail brine, discharges the raw eluate solution to an effluent tail brine tank using an effluent tail brine pump connected to the DLE processing device.

### TECHNICAL FIELD

The present disclosure relates generally to a process for the treatment of extracted tail brine as it exits from a bromine plant but before being processed by a direct lithium extraction device using lithium adsorption and desorption resins. More specifically, the processes for the treatment of tail brine exiting a bromine plant typically have a low pH (pH<2) value as well as a very high ORP value (>300 mV) due to residual bromine and chlorine in the extracted tail brine, therefore affecting the efficacy of said direct lithium extraction adsorption and desorption resins.

### BACKGROUND

### 1. Bromine Extraction Process

Brine was initially encountered as a result of drilling for oil and first produced in Columbia County, Arkansas. Nonetheless, the brine encountered with the oil and gas was initially considered a worthless by-product of production. Over time, the oil and gas industry realized that the brine contained elevated concentrations of elements, such as bromine in addition to hydrocarbons. Accordingly, the commercial potential of bromine gradually became apparent.

On Jan. 4, 1891, Herbert H. Dow succeeded in producing bromine electrolytically from Michigan's rich brine resources. In the years that followed, this and other processes developed by Dow and the company he founded led to an increasing stream of chemicals from brines. The commercial success of these endeavors helped to promote the growth of the American chemical industry.

The most recoverable form of bromine is from soluble salts found in seawater, salt lakes, inland seas, and brine wells. Sea water contains bromine in about 65 parts per million (ppm), but bromine is found in much higher concentrations (2,500 to 10,000 ppm) in inland seas and brine wells. Much of the bromine and brominated compounds are manufactured in the U.S., China, and at the Dead Sea in Israel and Jordan. Bromine is produced from brine after separation of most of the sodium chloride and potash.

One method currently used to extract bromine from seawater is the air blowing method, which is first blown, then adsorbed, then neutralized, and finally distilled. The process of blowing, absorption, and chlorination is a concentration process of Br₂, which is more efficient, less energy-consuming, and less costly than direct distillation of Br₂-containing seawater. The towers used for such process are typically 16-20 meters high, and the distillation tower and the neutralization towers are 10-12 meters high. As such, said process takes up a lot of space, consumes high energy, has low efficiency, and is not closed loop. As such, this method is most suitable for low-energy bromine-containing brines.

Another method is to extract bromine by steam distillation, which is directly oxidized by chlorine gas. The relative volatility of water vapor by bromine is large, and distillation is carried out by steam distillation. The product after distillation is allowed to stand for stratification, and the bromine layer is crude. The finished product is bromine. This method is more efficient than the air blowing method but is not widely used due to the high concentration of water containing bromine, and the high energy consumption required for preheating brine.

Based on the methods for extracting iodine, ion exchange resin adsorption began to be used as an alternative in the field of bromine extraction in the 1960s. First, during chlorination and oxidation bromide ion was changed to free bromide which was absorbed by the ion-exchange resin, then the loaded resins can desorb with H₂SO₃ and received bromide ion. At last, for eluting the bromine ion, which is adsorbed in the resin, the recycling agent just like hydrochloride is generally used. The eluent is then oxidized by chlorine and the steam distillation is applied to obtain the finished product. Since the 1970s, several experiments had been conducted on ion-exchange resin to increase bromine extraction effectively. The results showed that certain resins had a good absorptivity for bromide ion, but when sodium citrate was selected as a desorption agent. Nonetheless, the dynamic adsorption experiments showed that with increasing of the seawater flow rate, the penetration volume and the adsorbing capacities of resins decreased.

In the 1980s, gas membrane separation techniques were applied to bromine extraction from the brine as well as aqueous solutions containing traces of bromide. This technology assumed that bromine volatilized into gas between film holes and electrolyte interfaces when the material flowed through certain membrane pores. The advantages of such a separation technique proved to be highly efficient with no secondary contamination, lower energy consumption which just consumed half of the electric of the technique of air blow-out, simpler equipment, and more convenient operation. Many varieties of membranes have been used in the field such as polypropylene membranes, polyvinylidene fluoride (PVDF) hollow fiber membranes, emulsion liquid membrane. Yet they each posed their unique advantages and disadvantages such as reduced efficiency, breakage of liquid films, and therefore reduction in performance of bromine extraction.

Based on the lower stripping rate and higher energy consumption of the sour adsorption way of air stripping, the main technology of air stripping by high gravity is proposed for extracting bromine from brine domestically was later on introduced. The free bromine in the oxidized liquid was blown out by a high gravity separator which used the characteristic of the high strength mass transfer. In the high gravity field, under the gravity of the packing rotating, the liquid which was located in the top of the inlet and after distributed by liquid distributor was cut to the form of drop, liquid membrane, brine and so on which were conveyed from the inside packing to the outside. In fact, in 2009, Youzhi Liu, Linna Zhang, Yu Li, Weizhou Jiao, Xiangdan Song, Jiangze Han: Journal of Modern chemical industry Vol.29 (2009), p. 7, explored the effect of gas to liquid volume ratio, pH value, super gravity factor and total bromine concentration of oxidized liquid on the stripping rate of free bromine in the air stripping process by high gravity. The results showed that the single-stage and three-stage stripping rate of the oxidative liquid which the total bromine mass concentration was 250 mg/L were about 88% and 93% respectively under the operational conditions of temperature was 20-25 degrees Celsius, gas-liquid volume ratio was 120, pH value was 3.5, super-gravity factor was 84.67, which is about 10% higher than the air stripping rate of 75%-85% in the traditional tower equipment. Under the same operational conditions, the single-stage stripping rate was 94.5% with the total bromine mass concentration of 2000 mg/L provided. The stripping effect for bromine was remarkable, and the energy consumption was decreased. Later on, in 2011, Naijun Tan, Guoqiang Wang. Journal of Salt and Chemical Industry Vol. 40 (2011), p. 4, independently developed a gravity separator applied to the extraction of bromine. The blow out rate could reach 99.28% when the temperature was 25 degrees Celsius the material solution pH was 3.5, the high gravity factor was 143.75, the gas-liquid volume ratio was 80 and the packing was high density.

Lately, methods for extracting bromine from seawater by vacuum distillation have been used, which comprises the steps of heating (sometimes using solar energy), distilling with bromine-rich brine, adding chlorine gas to a supergravity tower, separating bromine and recovering waste gas.

Although some historical production of bromine occurred from sea water in the aforementioned regions, most (if not all) of U.S. bromine has been produced from subsurface brine in southern Arkansas. The first commercial recovery of bromine from brine in Arkansas occurred in 1957 in Union County and since then it has been continuous via a process in which the bromine-bearing brine is produced using production wells, the bromine is recovered through an exchange reaction with chlorine in surface facilities, and the bromine-free brine (effluent brine) is returned underground into the production formation via Class V injection wells that are regulated by the Arkansas Oil and Gas Commission. However, these brine aquifers found in Arkansas, have different characteristics than traditional mineral deposits, such as precious and base metal deposits and therefore require certain levels of pre-treatment prior to utilizing them in direct lithium extraction processes.

### 2. Pre-Treatment of Tail Brine

The tail-brine, which is produced as a by-product from a bromine extraction plant, is typically processed to produce battery-grade lithium carbonate in direct lithium extraction (DLE) process. Nonetheless, pre-treatment of said processed extracted tail brine is currently only performed to remove dissolved gases and suspended solids prior to lithium extraction. The processes used to perform such pre-treatments are industry standard and have been used on extracted tail brines for over 60 years as part of the bromine production process. Pre-treatment of incoming tail and bypass brine is necessary to remove residual hydrogen sulfide, suspended solids, and other contaminants which may result from brine extraction and bromine processing. Currently, continue testing of alternative filtration technologies is being performed to optimize brine filtration by varying the media and incoming brine temperature, pH, and ORP which also require that capital and operating costs be also optimized. Some of those key technologies that have been tested by the prior art include: (a) Chemical softening using carbon dioxide instead of sodium carbonate to minimize introduction of additional impurities; (b) Silica removal by pH adjustment; (c) Silica removal using a proprietary ion exchange approach, or (d) Silica removal by activated alumina. It has been found that the behaviors of potential fouling agents such as transition metals, dissolved silica, alkaline-earth metals, non-halide anions, etc. are complex and affected by subtle changes in pH, oxidation-reduction potential (ORP), pressure, temperature and reagent addition induced chemical reactions. The behavior of problematic elements is difficult to predict from either modelling, batch operation or short term (less than one year) operation. Therefore, the need to solve this problem is of utmost importance.

Hydrazine is an important industrial chemical, mainly used in feedwater deoxidation, as dehydrating agents or foaming agents, as a color treatment in brine solutions, as pharmaceutical intermediates, purification and as separation agents and rocket fuel. Hydrazine has 5%, 35%, 40%, 50%, 55%, 64%, 80%, 85% and 100% specifications according to its concentration. Among them, 80% hydrazine hydrate is immiscible with solvents such as ether and chloroform, but it is miscible with water and ethanol. Hydrazine hydrate can react with carbon dioxide in the air to form white mist. High-concentrations hydrazine hydrate not only have weak alkalinity and strong reducibility (reacts violently with oxidants and may even cause spontaneous combustion and self-explosion), but it is also a toxic substance. Hydrazine hydrate's strong reducibility allows it to be used as an antioxidant. It can also be used in the deoxidation process of power boiler water or as a cleaning agent in the electroplating industry. In chemical production, hydrazine hydrate can be used to produce different types of foaming agents. In medicine, it is a key component in the production of certain medicines. In addition, in the high-tech field, high-purity hydrazine hydrate is also required to produce rocket fuel and certain explosives. Nonetheless, with the development of science and technology and the continuous improvement of human living standards, the application fields of hydrazine hydrate are also expanding.

The production method of hydrazine hydrate mainly consists of the Raschig process, the Wyler's process, the ketazine process, peroxide passivation and air oxidation process, etc. Companies have tried to evaporate the waste brine to produce salt residue in the exploration of the reuse of hydrazine hydrate waste brine. Nonetheless, even though the solid salt obtained after calcination meets the requirements of chlor-alkali electrolysis brine reuse, the cost is significantly higher. Other methods of use that involve hydrazine hydrate in brine used bubbling-oxidations processes to reduce the organic content in the waste brine to less than 200 mg/L under high temperature conditions. Combining the dilute brine dichlorination system with the hydrazine hydrate production wastewater treatment and used the free chlorine in the dilute brine to oxidize the hydrazine hydrate wastewater, which not only improved the capacity of the chlorine system, but also made the hydrazine hydrate discharge of wastewater up to standard, saving operating costs.

An alternative to hydrazine is hydroxylamine. Hydroxylamine is a reactive chemical with formula NH2OH. It can be considered a hybrid of ammonia and water due to parallels it shares with each. At room temperature pure NH2OH is ordinarily a white, unstable crystalline, hygroscopic compound; however, it is almost always encountered as an aqueous solution. To date, hydroxylamine has been used across various industries as a reducing agent or as an antioxidant. With brine, hydroxylamine has been used in processes for removing or decreasing the color of a brine solution, as either the pure compound, a salt, the hydrate, or the like, in a sufficient amount to remove or decrease the amount of color present in said solution. This is done because color is frequently a problem for brines used in oil wells as one cannot see if impurities may arise in the preparation of a brine. Oftentimes, the impurities do not cause a noticeable color change until the brine is blended with another salt solution. Since there's a relatively high cost for high density brine, there is a strong motivation to reuse the brine solution. Nonetheless, recovered brine, having been downhole in an oil well, frequently acquires color rendering it generally unsuitable for reuse.

As it can be observed, the research direction pursued when employing hydrated hydrazine or hydroxylamine is oriented toward reducing organics and ammonia nitrogen content, purifying concentrated brine, reusing to chlorine ionic membrane electrolysis, or reducing color. Other processes using hydrazine hydrate or hydroxylamine have effectively demonstrated that it can be produced but with the fallout of producing large amounts of effluent brines in production process, thereby contaminating environment.

### 3. Direct Lithium Extraction Process

Traditionally, lithium (Li) has been mined from the Li-bearing minerals lepidolite, petalite, and spodumene contained in pegmatite formations. Lepidolite (K(Li, Al)₃(Al, Si, Rb)₄O₁₀(F, OH)2), contains 3.58% Li content. It is no longer a major mining ore due to its high fluorine content. Petalite (LiAlSi₄O₁₀), contains 2.09% Li content. Its high iron content and low thermal expansion rate make it ideal for glass and ceramics, but it is also used for electric vehicles (EV) and battery storage applications. Of the three minerals, spodumene (LiAl(SiO₃)₂), has the highest Li content at 3.73% (See Hanna Vikström, Simon Davidsson, Mikael Höök, Lithium availability and future production outlooks, Applied Energy, Volume 110, 2013, Pages 252-266, https://www.sciencedirect.com/science/article/pii/S0306261913002997). Its treatment chain can be completed in roughly 5 days and is consistently productive (Grosjean, C., Herrera Miranda, P., Perrin, M., and Poggi, P. (2012). Assessment of world lithium resources and consequences of their geographic distribution on the expected development of the electric vehicle industry. Renew. Sustain. Energy Rev. 16, 1735-1744. doi:10.1016/J.RSER.2011.11.023). The traditional sulfuric acid method for extracting Li from spodumene ores has a percent yield between 85% and 90% and a percent recovery of 60%-70% (See U.S. Pat. No 2,516,109). However, the pegmatite formations spodumene is contained in are challenging to mine given their hardness and occurrence in difficult-to-reach belt deposits (Grosjean et al., 2012). Additionally, the treatment process requires high-energy-demanding furnaces, pit-digging machines, and rock-crushing machines. Ultimately, these machines, the dust produced from excavation, and the concentrated chemicals used for processing cause environmental damage and pose health and safety risks (Aral, H., and Vecchio-Sadus, A. (2008). Toxicity of lithium to humans and the environment—A literature review. Ecotoxicol. Environ. Saf. 70, 349-356. doi:10.1016/J.ECOENV.2008.02.026). These drawbacks to Li recovery from terrestrial mining and the rapid depletion of Li ores have led to the innovative practice of recovering Li from salt lake brines, or Direct Lithium Extraction (DLE).

Nonetheless, DLE has the potential to significantly impact the lithium industry, with implementation on the extraction of lithium brines potentially revolutionary to production, capacity, timing, and environmental impacts and permitting. Several proven DLE technologies are emerging and being tested at scale, with a handful of projects already in commercial scale construction. The main challenges facing DLE technologies to date are the extraction technology's Li⁺ selectivity, separation efficiency, recovery, and lifetime. Though the application of technologies used in DLE processes may be fairly new to the lithium industry, many are already utilized across other commodities. Experts believe that DLE technologies can be implemented as soon as 2025 but market skepticism around commercial development of DLE technologies by the end of the decade still exists.

Lithium-containing salt lake brine generally contains magnesium ions, and the magnesium content directly affects the extraction of lithium. Generally, when a magnesium-to-lithium ratio (Mg/Li) is lower than 8-10, the natural evaporation concentration-precipitation method can be used and, if it is higher than 10, the magnesium and lithium are not easily separated. The technical methods of extracting lithium salt from salt lake brine mainly include precipitation method, extraction method, sorption methods, membrane methods, ion exchange adsorption method, carbonization method, calcination leaching method, electrodialysis method, etc. While there is increasing awareness of the technological implications of DLE around increased recoveries, production, and accelerated ramp-up of projects, the economics of its implementation, along with the implementation of the various technologies in other mineral commodity extraction, remain underappreciated. Therefore, the precipitation method, the extraction method, the adsorption method, and the carbonization method have been at the center of extensive studied and are the main methods currently used for extracting lithium from salt lake brine. Adsorption, ion exchange, and solvent extraction DLE technologies are already utilized across other commodities at commercial scale (and ion exchange is already utilized in some conventional lithium brine processing to manage impurities).

In most of the current DLE process flows, a pre-treatment of the extracted brine be it from the ground or a bromine plant needs to occur. During this step, the brine undergoes certain pre-treatment to remove impurities and enhance the concentration of lithium ions. Most of the times, pre-treatment involves adding hydrochloric to adjust the pH to neutrality, to increase the concentration of lithium ions and sodium ions to the crystallization of sodium chloride through an evaporator or open air, and then to use sodium carbonate to precipitate lithium ions. The prior art around such pre-treatment step has the following shortcomings: 1) Lithium and sodium cannot be completely separated and post-processing is also required; and 2) The recovery rate is low, and the recovery rate is only 50%.

In order to solve the problems of low adsorbent utilization rate and low utilization efficiency and high production and processing costs in the process of extracting lithium from salt lake brine one can find methods in the prior art in which a continuous adsorption system with a multi-way valve is combined with the lithium adsorbent. In such a process, series or parallel connected multiple columns are combined with the switching mode of the multi-way valve, so that quick adsorption of lithium is achieved when the material liquid flows through the bed. The steps of adsorption, pushing back of material by low-magnesium solution, desorption, pushing back of desorption solution by barren brine and the like in the whole process are operated simultaneously through automatic control, and the adsorption of lithium can be effectively realized by the above method. However, the tail brine entering such a DLE process device typically has a low pH (pH<2) as well as a very high ORP value (>300 mV) due to residual bromine and chlorine in the tail brine. To extract these lithium ions using DLE, one must then pass such extracted tail brine through an absorbent column. However, these columns cannot be subjected to low pH or high ORP values as it will cause premature degradation of the resins contained therein.

### 4. Adsorption and Desorption Resins

The resin adsorption method uses in direct lithium extraction (DLE), use lithium-ion exchange (IX) adsorbents such as titanium dioxide, metal phosphates, composite antimonates, manganese oxide, manganous hydroxide, aluminum salt type adsorbents and organic ion exchange resins to selectively treat salt lake brine with high magnesium-to-lithium ratio. It is assumed that about 85% of ion exchange resins in the market are composed of a polystyrene matrix. Another 10% are acrylic and composed of a polyacrylate matrix, and the remaining 5% are composed of specialty polymer matrices, such as phenol-formaldehyde. Key chemical characteristics of ion exchange resins include:
Capacity: The number of sites available for ion exchange (total capacity) or the measure of the useful performance obtained with the IX resin when it is operating in a column under a prescribed set of conditions (operating capacity).
Swelling: The hydration of the fixed ionic groups that increases with an increase in capacity to the limits imposed by the resin's polymer network.
Selectivity: The affinity of a resin for an ion; selectivity is determined by the ion's charge and the size of the ion's hydrated form.
Kinetics: The speed of the ion exchange. Stability: The tendency toward, or rate of, degradation.

In direct lithium extraction (DLE), use lithium-ion exchange (IX) adsorbents, the selective adsorbent is used to adsorb lithium ions, and then the lithium ions are eluted to achieve the purpose of separating lithium ions from other impurity ions. This method is simple in process, high in recovery rate and good in selectivity, as well as having great advantages compared with other methods. Some of the disadvantages of such a process include low adsorbent utilization rate, low utilization efficiency, high production, and processing costs in the process of extracting lithium from salt lake brine. To solve these problems, companies have introduced methods of continuous adsorption via a multi-way valve, combined with the lithium adsorbent. Under this process a series or parallel connected multiple columns are combined with the switching mode of the multi-way valve, so that quick adsorption of lithium is achieved when the material liquid flows through the bed. The steps of adsorption, pushing back of material by low-magnesium solution, desorption, pushing back of desorption solution by barren brine and the like in the whole process are operated simultaneously through automatic control, and the adsorption of lithium can be effectively realized by the above method. This method has the advantages of simple operation, low operating cost and high production efficiency with the big caveat that resins are delicate in that un-treated tail brine from bromine plants typically having a low pH (pH<2) value as well as a very high oxidation reduction potential (ORP) value (>300 mV) due to residual bromine and chlorine in the extracted tail brine, significantly affect the efficacy of said direct lithium extraction adsorption and desorption resins. Therefore, effective ion exchange DLE processes have not been implemented thus far.

### 5. Conclusion

As it can be observed, none of the references teach or suggest a method for the reduction of the ORP, as well as increasing pH levels to neutral for the use in a DLE process devices. It would therefore be desirable to develop a process that removes any guesswork in quite a capital and operational costly DLE process that finds itself affected by subtle changes in pH, oxidation-reduction potential (ORP), pressure, temperature and reagent addition induced chemical reactions. Although other reducing agents have been used to lower brine ORP, these will typically leave some byproduct in the brine which could be an issue later on for DLE devices.

### SUMMARY

The present invention attempts to solve one or more of the abovementioned needs, by providing a cost-effective, efficient, and stable method for treating extracted tail brine from a bromine plant having low pH levels (pH<2) as well as very high ORP values (>300 mV) which are typical conditions of extracted tail brine, due to having residual bromine and chlorine. Where others have failed, that is, at solely using ammonia as a conventional means to raise the pH, but keeping OPR values high, thereby affecting the key chemical characteristics of DLE ion exchange resins, embodiments of the present disclosure combine certain amounts of hydrazine hydrate or hydroxylamine hydrochloride with ammonia (ammonium hydroxide) or sodium hydroxide to not only raise the pH but to also lower the ORP values to less than 300 mV for either short or long periods of time. Embodiments use hydrazine or hydroxylamine as a more powerful reducing agent in small amounts which also provides the benefit that it does not remain in the extracted tail brine as it is oxidized to nitrogen and leaves the DLE processing device. Positive synergies were shown from embodiments of this disclosure due to the combination of caustic and hydrazine or hydroxylamine to keep brine ORP<100 mV. The combination of ammonium hydroxide and 195 ppm hydrazine or hydroxylamine was shown to keep the ORP value<300 mV for less than a day but, to keep ORP at a lower level for over a day higher dosage of hydrazine or hydroxylamine such as 195 ppm or 200 ppm were needed. On the other hand, the combination of caustic (sodium hydroxide) and 70 ppm hydrazine or hydroxylamine keeps the ORP value<100 mV for 11 days. Success of the present disclosure shows that overloading hydrazine or hydroxylamine does not degrade the adsorption/desorption resins as well as not caused premature degradation thereby helping with the key chemical characteristics of ion exchange resins. The method of the present disclosure treats tail brine extracted from a bromine plant, wherein said brine further contains residual bromine and chlorine with low pH and high Oxidation Reduction Potential (ORP) values to be used in a lithium extraction production facility. The method receives the extracted tail brine and conditions it in a conditioning tank prior to entering a DLE processing device with either (a) mixture having a maximum 4000 ppm of 50% sodium hydroxide ppm until the pH level of the pre-treated extracted tail brine is between 5.5 and 6.5, or (b) a mixture of about 2300 ppm 50% ammonium hydroxide solution until the pH level of the pre-treated extracted tail brine is between 5.5 and 6.5. It then pre-treats it with less than 70 parts per million (ppm) of hydrazine or hydroxylamine or 195 ppm of hydrazine or hydroxylamine (if using ammonium hydroxide) until the measured ORP level of the extracted tail brine in the brine conditioning tank has reached less than 100 millivolts (mV). These steps are done in such fashion to allow the method for the treatment of tail brine extracted from a bromine plant, to efficiently operate a DLE processing device and not cause the ion exchange resins to degrade over time, thereby affecting the capacity, selectivity, swelling, and kinetics of the entire lithium extraction production facility.

Once the extracted tail brine is pre-treated and conditioned, it is then sent using a centrifugal pump via an outlet feed connected to the brine conditioning tank the to a direct lithium extraction (DLE) processing device. The processing of the conditioned extracted tail brine with the DLE processing device occurs by moving through resin-filled adsorption columns the extracted tail brine, until the raw eluate solution is discharged via an effluent fiberglass pipeline system connected to an effluent tail brine tank using an effluent tail brine pump connected to the DLE processing device.

### BRIEF DESCRIPTION OF THE DRAWINGS

The teachings of the present invention can be readily understood by considering the following detailed description in conjunction with the accompanying drawings.

FIG. 1 is a simplified flowchart diagram of the method for the treatment of tail brine extracted from a bromine plant, when using less than 70 parts per million (ppm) of hydrazine or hydroxylamine and a mixture having a maximum 4000 ppm of 50% sodium hydroxide ppm until the measured ORP level of the extracted tail brine in the brine conditioning tank has reached less than 100 millivolts (mV) and its pH level is between 5.5 and 6.5, according to an embodiment of the present disclosure;

FIG. 2 is a simplified flowchart diagram of the method for the treatment of tail brine extracted from a bromine plant, when using less than 195 parts per million (ppm) of hydrazine or hydroxylamine and a mixture of about 2300 ppm 50% ammonium hydroxide solution until the measured ORP level of the extracted tail brine in the brine conditioning tank has reached less than 100 millivolts (mV) and its pH level is between 5.5 and 6.5, according to an embodiment of the present disclosure;

FIG. 3 illustrates a simplified block diagram of quasi-closed loop of a bromine plant connected to a lithium extraction production facility containing conditioning tank, a DLE processing devices, pumps, and an effluent tail brine tank;

FIG. 4 illustrates a simplified block diagram of a direct lithium extraction processing device having adsorption columns filled with lithium adsorption resins and interconnected via a multi-way valve system as used in the lithium extraction production facility, according to an embodiment of the present disclosure;

FIG. 5 illustrates a simplified flowchart diagram of a quasi-closed loop of a bromine plant connected to a lithium extraction production facility, according to an embodiment of the present disclosure;

FIG. 6 illustrates a chart showing the relationship between ORP levels and pH levels, for a mixture having maximum 4000 parts per million (ppm) of 50% sodium hydroxide and less than 70 ppm of hydrazine or hydroxylamine, according to an embodiment of the present disclosure; and

FIG. 7 illustrates a chart showing the relationship between ORP levels and pH levels, for a mixture of about 2300 parts per million (ppm) 50% ammonium hydroxide solution and 195 ppm of hydrazine or hydroxylamine, according to an embodiment of the present disclosure.

### DETAILED DESCRIPTION

### 1. Introduction

Reference will now be made in detail to several embodiments of the present disclosures, examples of which are illustrated in the accompanying figures. It is noted that wherever practicable similar or like reference symbols may be used in the figures and may indicate similar or like functionality. The figures depict embodiments of the present disclosure, for purposes of illustration only. One skilled in the art will readily recognize from the following description that alternative embodiments of the structures, systems, and methods illustrated therein may be employed without departing from the principles of the disclosure described herein.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

### 2. Description of the Preferred Embodiments

Pursuant to the above-defined objects, the present invention concerns itself with the treatment of extracted tail brine from bromine plant prior to entering a direct lithium extraction process using adsorbent and ion exchange technologies in a lithium extraction plant. Salt lakes brines possess complex concentrations of chlorine (Cl⁻), sodium (Na⁺), potassium (K⁺), magnesium (Mg²⁺), calcium (Ca²⁺), copper (Cu²⁺), nitrate (NO₃⁻), bicarbonate (HCO₃⁻), sulfate (SO₄²⁻) and other ions, albeit seawater at lower concentrations. On average, the total dissolved solids in salt lake brines range from 170,000 to 330,000 ppm, compared to 500 to 30,000 ppm in seawater; while Li⁺ concentrations typically range from 54 to 1,600 ppm in salt lake brines, compared to a range of 0.1-0.2 ppm in seawater. Salt lake brines can generally be classified into four main types based on their composition: carbonate (CO₃²⁻), sodium sulfate (Na₂SO₄), magnesium sulfate (MgSO₄), and chloride (Cl⁻), however, only carbonate brine types have been the most economical and sustainable bromine and lithium extraction resources for traditional evaporation and precipitation extraction methods due to their low Mg²⁺/Li⁺ mass ratios and higher Li⁺ concentrations relative to the other solutions. Nonetheless, the main drawback of any of the existing technology is the sensitivity to ORP and pH and the concentration of competing ions during the co-precipitation processes. If the concentration of these ions, the ORP levels, or pH values are not controlled they become impurities that decrease the co-precipitation efficiency and quality of the co-products.

Thus, certain embodiments of the present disclosure demonstrate first the use of ammonium hydroxide or caustic (particularly sodium hydroxide) to normalize the pH levels and then, for the ORP, a hydrazine derivative selected from a group consisting of anhydrous hydrazine, hydrazine monohydrate, aqueous hydrazine, hydrazine acetate, hydrazine dihydrochloride, hydrazine monohydrochloride, hydrazine sulfate, hydrazine hemisulfate, and hydrazine monohydrobromide. In particular embodiments, the hydrazine derivative is hydrazine hydrate. In other embodiments the ORP reducing agent is hydroxylamine. Similarly, other embodiments of the present disclosure demonstrate first the use of ammonium hydroxide or caustic (particularly sodium hydroxide) to normalize the pH levels and then, for the ORP, a hydroxylamine solution derivative essentially consisting of hydroxylamine hydrochloride.

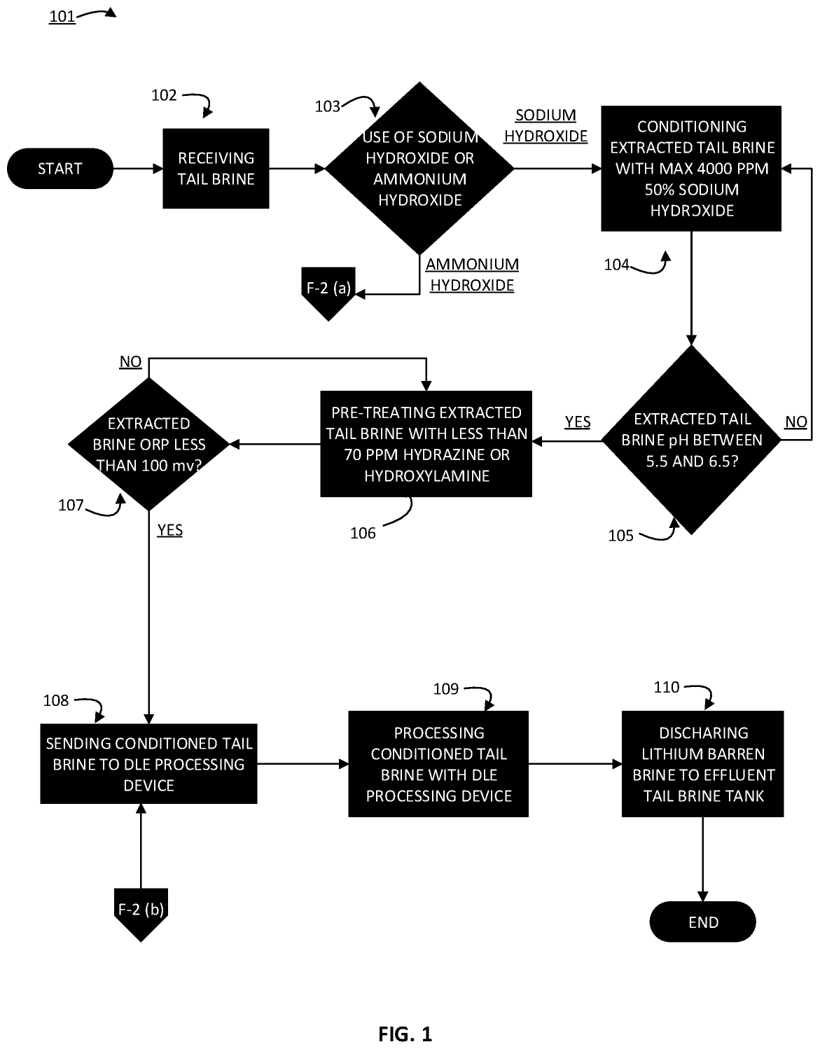

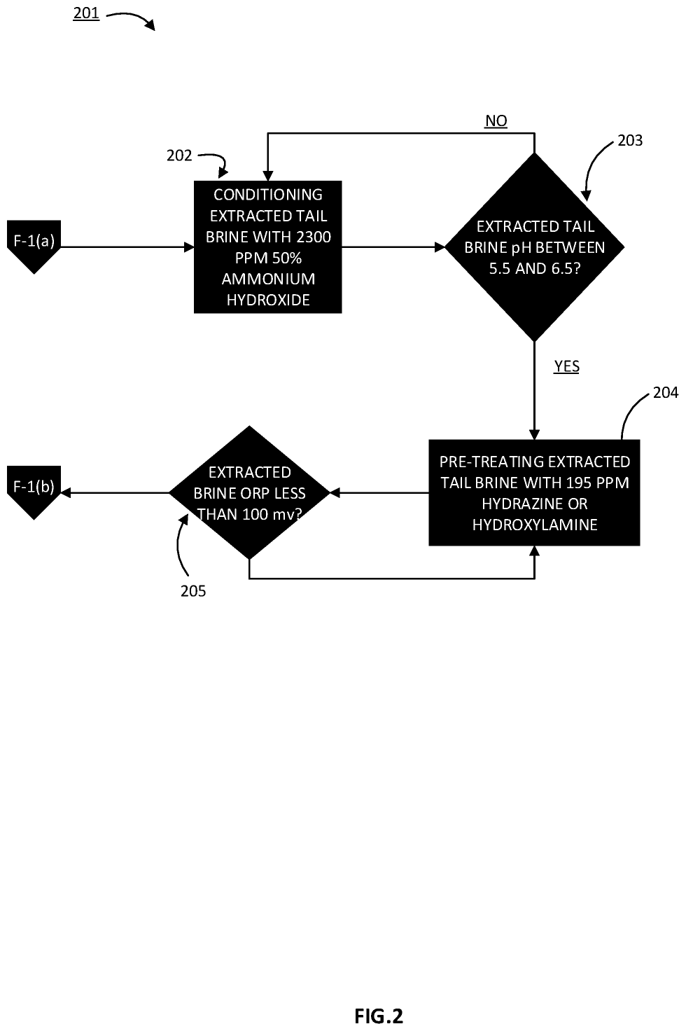

The present disclosure is illustrated by FIG. 1 and FIG. 2 showing a simplified flowchart diagram of the method for the treatment of tail brine extracted from a bromine plant 303, when using less than 70 parts per million (ppm) of 5% to 60% of a hydrazine hydrate solution (or hydroxylamine solution) and a mixture having a maximum 4000 ppm of 50% sodium hydroxide ppm (101) or when using 195 parts per million (ppm) a mixture of about 2300 ppm 50% ammonium hydroxide solution (201); until the measured ORP level of the extracted tail brine in the brine conditioning tank has reached less than 100 millivolts (mV) and its pH level is between 5.5 and 6.5.

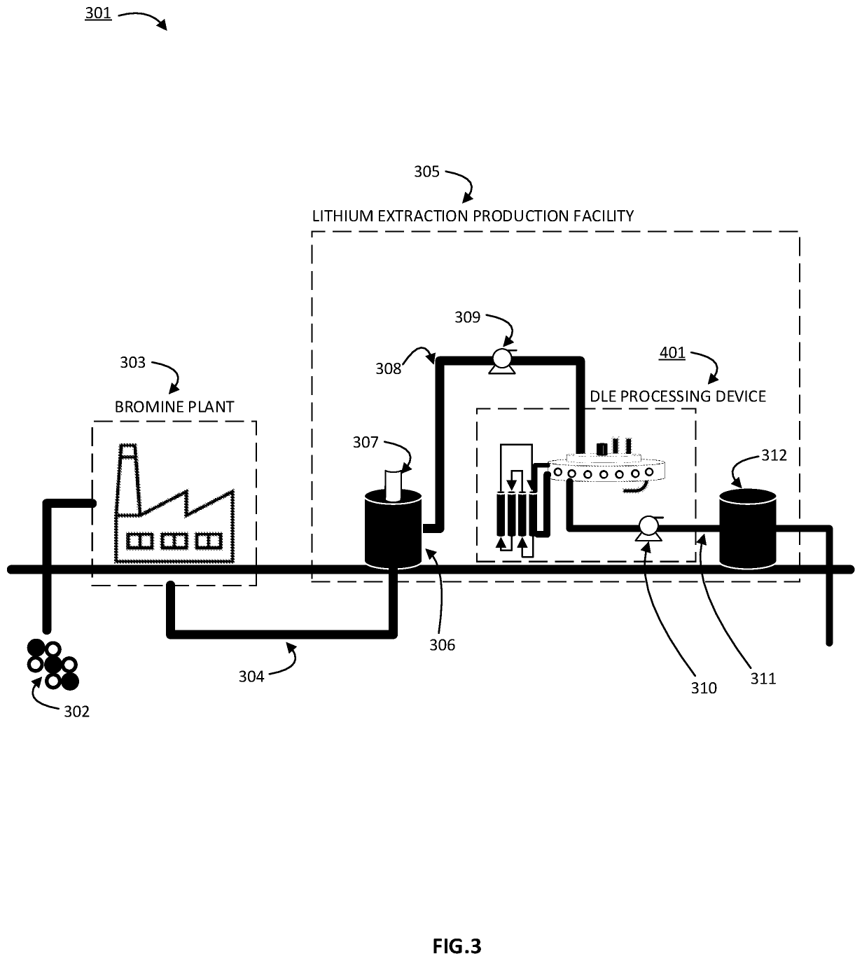

The present disclosure starts by receiving at 102, via a network of fiberglass pipelines 304 connecting the bromine plant 303 to the lithium extraction production facility 305 the extracted tail brine (also referred to as bromine-free brine or effluent brine) from the bromine plant 303 to a conditioning tank 306. This brine to bromine plant to lithium extraction production facility is illustrated by a simplified block diagram on FIG. 3, showing a quasi-closed loop further containing conditioning tank, a DLE processing device, pumps, and an effluent tail brine tank.

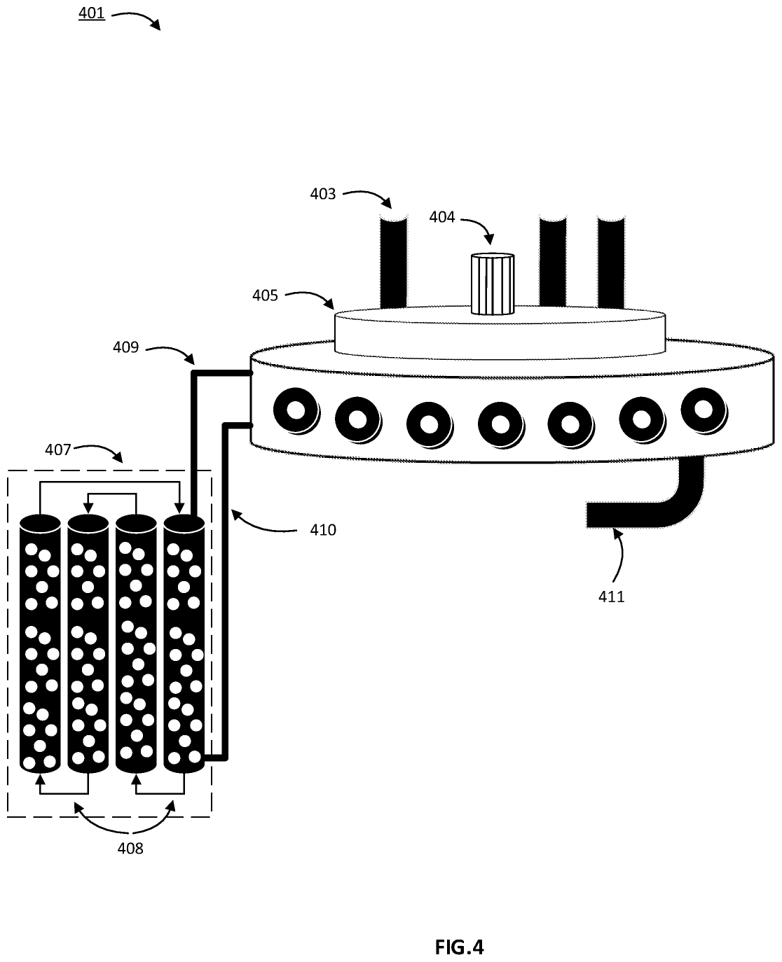

The process in which the bromine-bearing brine 302 is extracted at 303 using production wells, is typically performed through an exchange reaction with chlorine in surface facilities 303. Thereafter, conditioning at 103 of the pre-treated extracted tail brine occurs by either adding through the inlet feed 307 connected to the brine conditioning tank 306, a (i) mixture having a maximum 4000 ppm of 50% sodium hydroxide 104 until the pH level of the pre-treated extracted tail brine is between 5.5 and 6.5 105; or (b) a mixture of about 2300 ppm 50% ammonium hydroxide solution 202 until the pH level of the pre-treated extracted tail brine is between 5.5 and 6.5 203. The decision to condition the extracted tail brine in the conditioning tank 306 with either sodium hydroxide 104 or ammonium hydroxide 202 depends upon the availability of either solutions within the lithium extraction production facility 305. Once the extracted tail brine in the conditioning tank has reached a pH level between 5.5 and 6.5, the pre-treating at 106 of the extracted tail brine occurs by adding, through the inlet feed 307 connected to the brine conditioning tank 306, with less than 70 parts per million (ppm) of 5% to 60% of a hydrazine hydrate solution (or hydroxylamine solution) 106 or 195 ppm of hydrazine or hydroxylamine (if ammonium hydroxide is used) 204 until at 107 or 206, the measured ORP level of the extracted tail brine in the brine conditioning tank has reached less than 100 millivolts (mV). Industry standard inline ORP and pH control systems or meters the respective levels prior to sending, at 108, via an outlet feed 308 connected to the brine conditioning tank 306, the pre-treated extracted tail brine to a direct lithium extraction (DLE) processing device. Sending 108 of extracted tail brine of 107 occurs by means of centrifugal pump 307 which is connected to the DLE processing device 401 of FIG. 4 via a feeding piping system 403 located above a rotary disc 404 of the multi-way valve system 405. The DLE processing device then processes at 109 the pre-treated extracted tail brine by passing it through respective feeding piping systems located above (403 and 409) or below (410 and 411) a rotary disc of the multi-way valve system multi-way valve system 405 to respectively enter corresponding adsorption columns 407, which may be connected in series or in parallel via ducts and channels at the top and bottom 408 (filled with a lithium adsorption resins) connected the multi-way valve system 405. Processing at 109 the conditioned extracted tail brine with the DLE processing device 401 occurs by processing the extracted brine into a first adsorption column to perform adsorption of lithium ions onto an adsorbent and then into a second adsorption column for combining the pre-treated extracted tail brine with a low-magnesium solution. After the adsorbent is saturated, a third adsorption column containing a desorption solution desorbs the resin, producing a rich solution. The pre-treated extracted tail brine is then pushed into a fourth adsorption column which pumps back the desorption solution while discharging occurs at 110 of the raw eluate solution via an effluent fiberglass pipeline system 311 connected to an effluent tail brine tank 312 using an effluent tail brine pump 310 connected to the DLE processing device 401. The raw eluate solution will contain approximately 95% of lithium recovery and will have rejected more than 98% of the major contaminants for sodium, calcium, magnesium, and potassium. This raw eluate solution may then be sent to the for further processing such as purification, concentration, and electrolysis.

The raffinate or lithium-barren brine from the DLE processing device will also be pumped to an effluent lithium-barren brine tank where other waste processes such as filter backwash and resin regeneration streams are combined. Given that pH level of the lithium-barren brine will be between 5.5 and 6.5, there is no need to any prior pH adjustments to achieve a final complaint discharge. This PH levels in lithium-barren brine are required to:
(i) Avoid any precipitation issues in the brine injection wells; and,
(ii) Meet best-practice guidelines for reinjection of effluent brine into the Smackover Formation.

The desorption solution is selected from the group consisting of 0.1-50% (w/w) aqueous electrolyte solution, desalted water, 0.1-50% (w/w) saline solution, 0.1-36% (w/w) hydrochloric acid solution, 0.1-50% (w/w) sodium hydroxide solution, and any mixture thereof; preferably 0.5% (w/w) aqueous electrolyte solution, desalted water or 0.5% (w/w) hydrochloric acid solution; and most preferably desalted water.

The DLE processing device 401 has a feed flow rate of about 2 t/h for the brine, with each column being filled with 1 m³ of resin and the total amount of adsorbent in the system being 28 m³, and a switching time of 30 min.

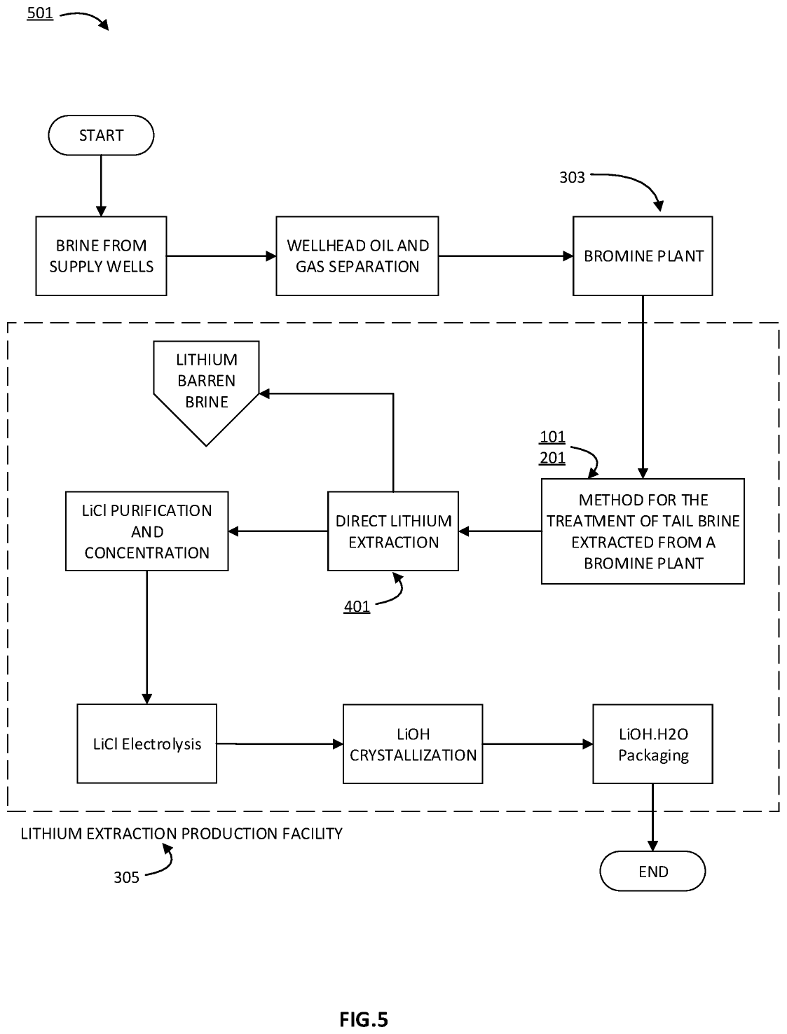

Turning over to FIG. 5, it illustrates a simplified flowchart diagram 501 of a quasi-closed loop of a bromine plant connected to a lithium extraction production facility. The flowchart illustrates how embodiments of the present disclosure interact with the different elements present in bromine and lithium extraction. To perform the steps shown in FIG. 5 a typical lithium extraction production facility 305 would comprise:
(i) a fresh water supply and distribution system;
(ii) a natural-gas-fired boiler unit to provide steam pressure to the lithium extraction production facility;
(iii) a power supply to provide energy for performing steps of receiving, pre-treating, conditioning, sending, processing, and discharging;
(iv) a compressed air supplied to control moisture content within the lithium extraction production facility;
(v) a sour gas transfer system for either reinjection or treatment of sour gas gathered at the lithium extraction production facility; and
(vi) auxiliary facilities for the operation of the lithium extraction production facility.

### 3. Example 1—Hydrazine With Sodium Hydroxide

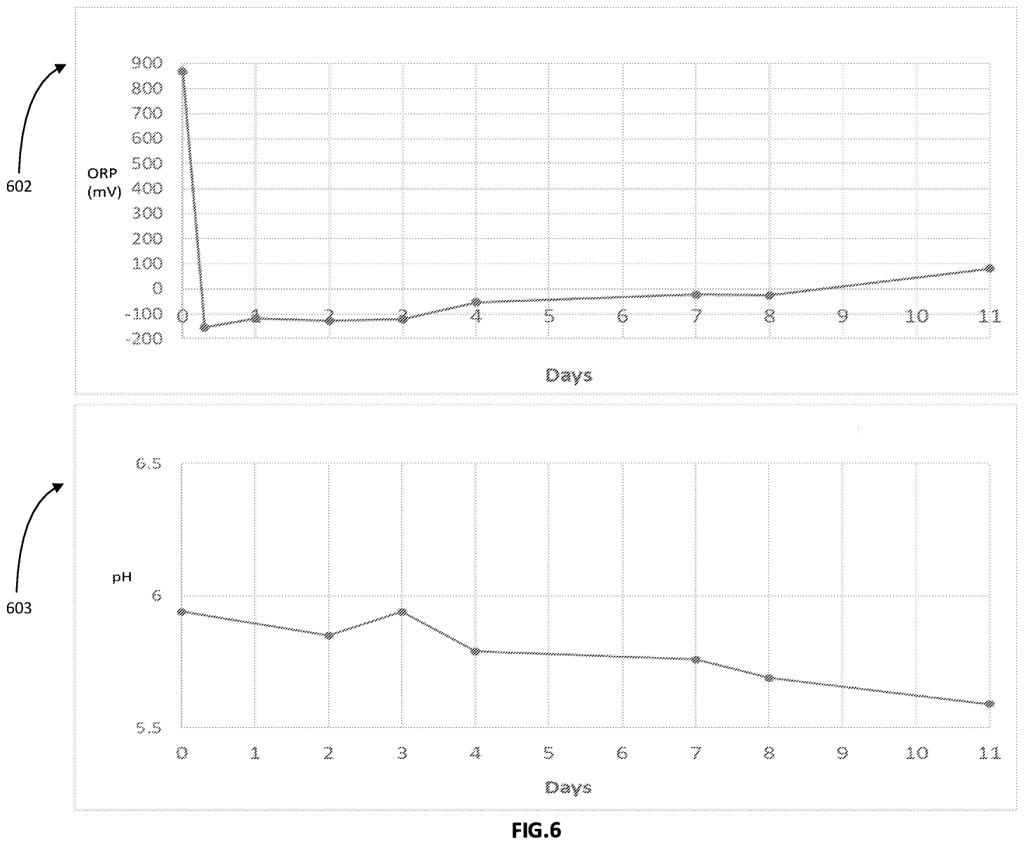

Turning over to FIG. 6, it illustrates in graph form the ORP values 602 and pH values 603 of the extracted tail brine after it has completed the method for the treatment of tail brine extracted from a bromine plant, wherein said brine further contains residual bromine and chlorine with low pH and high Oxidation Reduction Potential (ORP) values to be used in a lithium extraction production facility when conditioning 104 it with a maximum 4000 parts per million (ppm) of 50% sodium hydroxide and pre-treating it with less than 70 ppm of hydrazine 106.

The experiment results disclosed in FIG. 6 consists of an extracted tail brine of Smackover brine (after bromide conversion to bromine) with the following characteristics:
Starting pH level: 0.54
Starting ORP level greater than 800 mV

The extracted tail brine was conditioned with a 50% sodium hydroxide solution (7 ml to 4566.74 g of brine) thereby increasing the pH level to 6.44, while then pre-treated with 70 ppm of hydrazine (0.6385 g of 50% hydrazine hydrate) which brought the pH level of the extracted tail brine to pH 5.94 and the ORP to −130 mV. The DLE processing device started its DLE cycle and, upon completion, the raw eluate solution from the pre-treated extracted tail brine after eleven days showed a pH level of 5.59 and an ORP level of 80.5 mV.

### 4. Example 2—Hydrazine With Ammonium Hydroxide

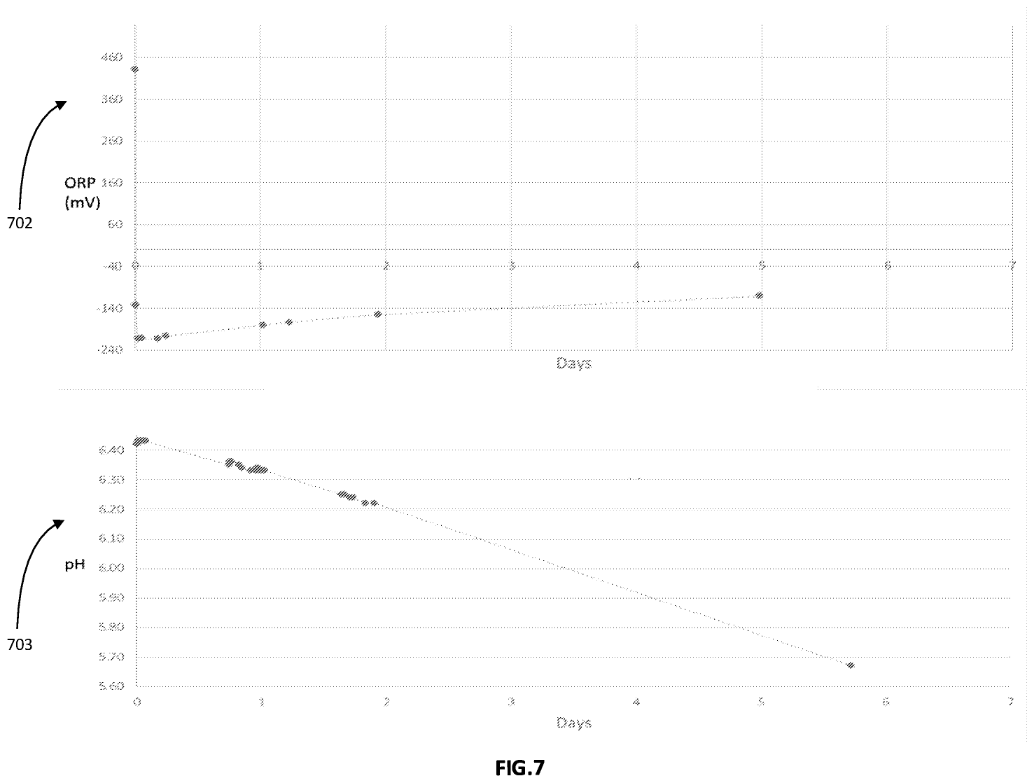

FIG. 7 illustrates in graph form the ORP values 702 and pH values 703 of the extracted tail brine after it has completed the method for the treatment of tail brine extracted from a bromine plant, wherein said brine further contains residual bromine and chlorine with low pH and high Oxidation Reduction Potential (ORP) values to be used in a lithium extraction production facility when conditioning 104 it with a mixture of about 2300 parts per million (ppm) 50% ammonium hydroxide solution 203 and 195 ppm of 5% to 60% of a hydrazine hydrate solution (or hydroxylamine solution) 204.

When combined with ammonium hydroxide, of 5% to 60% of a hydrazine hydrate solution (or hydroxylamine solution) was discovered to reduce the ORP of tail brine more rapidly than ammonia. The reduction in ORP was primarily due to hydrazine, while ammonia played a minor role. Conversely, ammonia was mainly responsible for the change in pH, with hydrazine having a much smaller effect.

To achieve less than 100 mV in a reasonable amount of time, a diluted solution of hydrazine (0.107%) was used. The use of hydrazine was minimal, with a total dosage of 2.3 ppm being sufficient to maintain the tail brine ORP below 300 mv for 10 hours. After the 10-hour period, when the ORP rebounded, it could be easily suppressed with additional hydrazine dosage. A total dosage of 16 ppm was sufficient to maintain the extracted tail brine ORP below 300 mv for 4 hours. The combined use of ammonia and hydrazine resulted in fewer pH changes than ammonia alone. Yet, it wasn't until the conditioning 202 of the extracted tail brine with a mixture of about 2300 parts per million (ppm) 50% ammonium hydroxide solution and a pre-treating with 195 ppm of 5% to 60% of a hydrazine hydrate solution (or hydroxylamine solution) 204, that the ORP level decreased without rebounds over 100 mv.

These examples further showed that the extracted tail brine when pre-treated with 5% to 60% of a hydrazine hydrate solution (or hydroxylamine solution) can be stored indefinitely, so long it contained in a sealed environment to avoid significant levels of pH decreases. These decreases in pH may be caused by exposure to CO₂ when the container is opened to air.

### 5. Abbreviations and Definitions not Elsewhere Defined

The Lit adsorption capacity, selectivity, separation efficiency, recovery, regeneration, cyclical stability, thermal stability, environmental durability, product quality, extraction time, low ORP values, optimal pH value, and specific energy consumption are also highlighted when provided in the present disclosure. The adsorption capacity is the maximum amount of Li⁺ that can be absorbed by the technology. Selectivity is the technology's ability to exclusively select Li⁺ or other desired ions over competing ions present in the solution. The separation efficiency is a measure of the quality of Li⁺ separation from the solution achieved by the technology. It is measured by the ratio of the Li⁺ concentrate removed from the solution feed stream to the initial Li⁺ concentration in the solution. Furthermore, the recovery is the amount or percentage of pure Li product obtained after extraction and additional treatment processes as described herein. Regeneration refers to the number of times the technology can be regenerated using a treatment process without significant losses in recovery. The cyclical stability indicates the number of times a technology can be reused before there are major losses in recovery. Thermal stability indicates the operating temperature(s) at which the technology achieves optimal performance. Environmental durability refers to the number of times the technology can be reused with minimal physical degradation. The product quality is the percent purity of the Li product recovered. The extraction time is the duration required to remove Li⁺ and recover the Li product. The ORP and pH values are the recommended solutions of ORP and pH for optimal Li⁺ extraction and recovery using the DLE embodiments described herein.

It is noted here that as used in this specification and the appended claims, the singular forms “a,” “an,” and “the” include plural reference unless the context clearly dictates otherwise. Similarly, as gerunds are derived from their respective verb word form, they include their word reference as well as the verb includes the gerund, unless context clearly dictates otherwise.

All percentages, pans, and ratios are based upon the total weight of the compositions of the present invention, unless otherwise specified. All such weights as they pertain to listed ingredients are based on the active level and therefore do not include solvents or by-products that may be included in commercially available materials, unless otherwise specified. The term “weight percent” may be denoted as “wt. %” herein. All molecular weights as used herein are weight average molecular weights expressed, as grams/mole, unless otherwise specified.

As used herein, an “aqueous solution”, “aqueous fluid solution”, or “aqueous fluid” is a solution generally made of water and ions, atoms or molecules that have lost or gained electrons, and is electrically conductive. The “Zinc Bromide to aqueous fluid” comprises at least 25 wt. % of water (by weight of the Zinc Bromide), a purity of less than 1 ppm of trace metals selected from a group consisting of Ag, Al, As, B, Ba, Be, Cd, Co, Cr, Cu, Fe, Li, Mn, Mo, Nb, Ni, P, Pb, Sb, Se, Si, Sn, Sr, Ti, and V; and less than 10 ppm of metals selected from a group consisting of Ca, K, Na, and Mg.

While in the foregoing specification this disclosure has been described in relation to certain preferred embodiments thereof, and many details have been set forth for purpose of illustration, the invention is not to be unduly limited to the foregoing which has been set forth for illustrative purposes. On the contrary, a wide variety of modifications and alternative embodiments will be apparent to a person skilled in the art, without departing from the true scope of the invention, as defined in the claims set forth below. Additionally, it should be appreciated that structural features or method steps shown or described in any one embodiment herein can be used in other embodiments as well. When references throughout this specification discuss “one embodiment”, “an embodiment”, or “embodiments” they shall take the meaning that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment.

As used herein, “and/or” placed between a first entity and a second entity means one of (a) the first entity, (b) the second entity, and (c) the first entity and the second entity. Multiple elements listed with “and/or” should be construed in the same fashion, i.e., “one or more” of the elements so conjoined. Furthermore, the terms “comprising,” “consisting,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended.

Unless indicated otherwise, when a range of any type is disclosed or claimed, it is intended to disclose or claim individually each possible number that such a range could reasonably encompass, including any sub-ranges encompassed therein.

We claim:

1. A method for the treatment of tail brine extracted from a bromine plant, wherein said brine further contains residual bromine and chlorine with low pH and high Oxidation Reduction Potential (ORP) values to be used in a lithium extraction production facility. The method comprising the steps of:
(i) receiving, via a network of fiberglass pipelines connecting the bromine plant to the lithium extraction production facility the extracted tail brine to a conditioning tank;
(ii) conditioning, the extracted tail brine by adding through an inlet feed connected to the brine conditioning tank, a mixture having a maximum 4000 parts per million (ppm) of 50% sodium hydroxide, until the pH level of the pre-treated extracted tail brine is between 5.5 and 6.5;
(iii) pre-treating the conditioned extracted tail brine by adding, through the inlet feed connected to the brine conditioning tank, with less than 70 ppm of a solution selected from the group consisting of hydrazine or hydroxylamine until the measured ORP level of the extracted tail brine in the brine conditioning tank has reached less than 100 millivolts (mV);
(iv) sending, via an outlet feed connected to the brine conditioning tank the pre-treated extracted tail brine to a direct lithium extraction (DLE) processing device;
(v) processing the pre-treated extracted tail brine with the DLE processing device; and
(vi) discharging, a raw eluate solution from the pre-treated extracted tail brine via an effluent fiberglass pipeline system connected to an effluent tail brine tank using an effluent tail brine pump connected to the DLE processing device.

2. The method for the treatment of tail brine extracted from a bromine plant of claim 1, wherein said extracted tail brine further comprises residual bromine and chlorine with pH value of less than 2, an ORP value greater than 300 mV.

3. The method for the treatment of tail brine extracted from a bromine plant of claim 1, wherein the solution selected from the group consisting of hydrazine or hydroxylamine in the step of pre-treating the extracted brine by adding, through the inlet feed connected to the brine conditioning tank, with less than 70 ppm of hydrazine or hydroxylamine, further comprises between 5% to 60% of a hydrazine hydrate solution or 5% to 60% of a hydroxylamine hydrochloride solution.

4. The method for the treatment of tail brine extracted from a bromine plant of claim 1, wherein the inlet feed connected to the brine conditioning tank in the steps conditioning and pre-treating, and the outlet feed connected to the brine conditioning tank in the step of sending, further comprises ORP and pH control systems for maintaining and verifying that the ORP level of the extracted tail brine to be less than 100 millivolts (mV) and the pH level of the extracted tail brine between 5.5 and 6.5.

5. The method for the treatment of tail brine extracted from a bromine plant of claim 1, wherein the DLE processing device within the step of processing the conditioned brine with the DLE processing device, further comprises:
(i) four groups of adsorption columns filled with lithium adsorption resins and interconnected via a multi-way valve system;
(ii) passing the pre-treated extracted brine and the lithium adsorption resins through respective feeding piping systems located above or below a rotary disc of the multi-way valve system; and
(iii) feeding the extracted brine and the lithium adsorption resins through the corresponding groups of adsorption columns using ducts and channels connected to the four groups of adsorption columns.

6. The method for the treatment of tail brine extracted from a bromine plant of claim 5, wherein the four groups of adsorption columns are connected in series or in parallel by channels to the multi-way valve system.

7. A method for the treatment of tail brine extracted from a bromine plant, wherein said brine further contains residual bromine and chlorine with low pH and high Oxidation Reduction Potential (ORP) values to be used in a lithium extraction production facility. The method comprising the steps of:
(i) receiving, via a network of fiberglass pipelines connecting the bromine plant to the lithium extraction production facility the extracted tail brine to a conditioning tank;
(ii) conditioning, the pre-treated extracted tail brine by adding through an inlet feed connected to the brine conditioning tank, a mixture of about 2300 parts per million (ppm) 50% ammonium hydroxide solution until the pH level of the pre-treated extracted tail brine is between 5.5 and 6.5;
(iii) pre-treating the conditioned extracted tail brine by adding, through the inlet feed connected to the brine conditioning tank, with less than 70 ppm of a solution selected from the group consisting of hydrazine or hydroxylamine until the measured ORP level of the extracted tail brine in the brine conditioning tank has reached less than 100 millivolts (mV);
(iv) sending, via an outlet feed connected to the brine conditioning tank the pre-treated extracted tail brine to a direct lithium extraction (DLE) processing device;
(v) processing the pre-treated extracted tail brine with the DLE processing device; and
(vi) discharging, a raw eluate solution from the pre-treated extracted tail brine via an effluent fiberglass pipeline system connected to an effluent tail brine tank using an effluent tail brine pump connected to the DLE processing device.

8. The method for the treatment of tail brine extracted from a bromine plant of claim 7, wherein said extracted tail brine further comprises residual bromine and chlorine with pH value of less than 2, an ORP value greater than 300 mV.

9. The method for the treatment of tail brine extracted from a bromine plant of claim 7, wherein the solution selected from the group consisting of hydrazine or hydroxylamine in the step of pre-treating the extracted brine by adding, through the inlet feed connected to the brine conditioning tank, with less than 195 ppm of hydrazine or hydroxylamine, further comprises between 5% to 60% of a hydrazine hydrate solution or 5% to 60% of a hydroxylamine hydrochloride solution.

10. The method for the treatment of tail brine extracted from a bromine plant of claim 7, wherein the inlet feed connected to the brine conditioning tank in the steps conditioning and pre-treating, and the outlet feed connected to the brine conditioning tank in the step of sending, further comprises ORP and pH control systems for maintaining and verifying that the ORP level of the extracted tail brine to be less than 100 millivolts (mV) and the pH level of the extracted tail brine between 5.5 and 6.5.

11. The method for the treatment of tail brine extracted from a bromine plant of claim 7, wherein the DLE processing device within the step of processing the conditioned brine with the DLE processing device, further comprises:
(i) four groups of adsorption columns filled with lithium adsorption resins and interconnected via a multi-way valve system;
(ii) passing the pre-treated extracted brine and the lithium adsorption resins through respective feeding piping systems located above or below a rotary disc of the multi-way valve system; and
(iii) feeding the extracted brine and the lithium adsorption resins through the corresponding groups of adsorption columns using ducts and channels connected to the four groups of adsorption columns.

12. The method for the treatment of tail brine extracted from a bromine plant of claim 11, wherein the four groups of adsorption columns are connected in series or in parallel by channels to the multi-way valve system.
